(19) United States
(12) Patent Application Publication
(10) Pub. No.: US 2016/0279610 A1
(43) Pub. Date: Sep. 29, 2016

(54) ZONED DIESEL OXIDATION CATALYST

(71) Applicant: UMICORE AG & CO. KG, Hanau-Wolfgang (DE)

(72) Inventors: Martin SYMALLA, Darmstadt (DE); Frank-Walter SCHUETZE, Haibach (DE); Michael SCHIFFER, Hanau (DE); Christoph HENGST, Butzbach (DE); Katja ADELMANN, Hanau (DE); Gerald JESKE, Neuberg (DE)

(73) Assignee: UMICORE AG & CO. KG, Hanau-Wolfgang (DE)

(21) Appl. No.: 14/442,300

(22) PCT Filed: Dec. 2, 2013
(86) PCT No.: PCT/EP2013/075205

§ 371 Date: May 12, 2015

(30) Foreign Application Priority Data
Dec. 6, 2012 (EP) 12195774.0

(51) Int. Cl. B01J 23/44; B01J 35/04; B01D 53/94; B01J 35/00

(52) U.S. Cl. CPC B01J 23/44; B01J 35/0006; B01J 35/04; B01D 53/944; B01D 53/9477; B01D 2255/1021; B01D 2255/1023; B01D 2255/9032

(57) ABSTRACT

The present invention relates to a zoned diesel oxidation catalyst, wherein the first catalytically active zone and the second catalytically active zone have equal thermal masses, the first catalytically active zone and the second catalytically active zone each contain platinum and palladium as catalytically active constituents, the weight ratio of platinum to palladium in the first catalytically active zone and the second catalytically active zone is the same in each case or is greater in the first catalytically active zone than in the second catalytically active zone, and the total concentration of platinum and palladium in the first catalytically active zone is greater than in the second catalytically active zone.

The present invention relates to a zoned oxidation catalyst for cleaning the exhaust gases of diesel engines.

The untreated exhaust gas of diesel engines contains, as well as carbon monoxide CO, hydrocarbons HC and nitrogen oxides NOₓ, a relatively high oxygen content of up to 15% by volume. Also present are particulate emissions which consist predominantly of soot residues, with or without organic agglomerates, and result from partially incomplete fuel combustion in the cylinder.

While diesel particulate filters with and without catalytically active coating are suitable for removal of the particulate emissions and nitrogen oxides can be converted to nitrogen, for example, by selective catalytic reduction (SCR) over what is called an SCR catalyst, carbon monoxide and hydrocarbons are rendered harmless by oxidation over a suitable oxidation catalyst.

Oxidation catalysts are described extensively in the literature. These are, for example, what are called flow-through substrates made from ceramic or metal, which bear noble metals, such as platinum and palladium, as essential catalytically active constituents on high-surface area, porous, high-melting oxides, for example alumina.

There have also already been descriptions of zoned oxidation catalysts having, in flow direction of the exhaust gas, materials zones of different composition with which the exhaust gas comes into successive contact.

For instance, US2010/257843 describes a zoned oxidation catalyst containing platinum and palladium, with at least 50% of the total palladium content in the first zone and at least 50% of the total platinum content in the second zone. The first zone is that with which the exhaust gas comes into contact first, i.e. that which begins on the inlet side of the substrate. US2011/099975 and WO2012/079598 A1 also describe a zoned oxidation catalyst containing platinum and palladium. The total amount of platinum and palladium in the first zone is high compared to the second zone, and the ratio of platinum to palladium is relatively low in the first zone and relatively high in the second zone. Here too, the first zone is that with which the exhaust gas comes into contact first.

WO 2011/057649 describes oxidation catalysts which can be used in layered and zoned embodiments. In the case of the zoned embodiments, the second zone, i.e. the zone with which the exhaust gas flowing away is in direct contact, has a higher noble metal content than the front zone which is in direct contact with the exhaust gas flowing in. The oxidation catalysts according to WO2011/057649 have the particular task of establishing an optimal ratio of NO to NO₂ for an SCR catalyst on the outflow side.

In the oxidation catalyst according to US2011/286900 too, the noble metal loading in the outlet zone is greater than in the inlet zone.

DE 102010063714 A1 describes zoned catalysts for a motor vehicle having an engine “stop-start” system, in which the thermal masses of the two zones are different.

Zoned platinum- and palladium-containing oxidation catalysts are also described in US2011/206584.

The exhaust gas temperatures of current and future diesel engines conforming to the 5, 6 and 6+ exhaust gas legislation are becoming ever colder as a result of fuel savings to lower CO₂ emission. It is all the more important to have available diesel oxidation catalysts having adequate CO light-off at the low exhaust gas temperatures. The diesel oxidation catalysts known to date do not satisfy this condition to an adequate degree, and so there is a need for corresponding development.

It has now been found that the diesel oxidation catalysts described and defined hereinafter fulfill these conditions.

The present invention relates to a diesel oxidation catalyst comprising a support body of length L which extends between a first end and a second end, and a catalytically active coating disposed on the support body, composed of a first catalytically active zone and a second catalytically active zone, wherein
the support body is a ceramic or metallic flow-through honeycomb,
the first catalytically active zone, proceeding from the first end,
extends for a length E of 5% to 95% of the total length L,
the second catalytically active zone, proceeding from the second end,
extends for a length Z of 5% to 95% of the total length L,

E+Z≦L,
the first catalytically active zone and the second catalytically active zone have equal thermal masses,
the first catalytically active zone and the second catalytically active zone each contain platinum and palladium as catalytically active constituents,
the weight ratio of platinum to palladium in the first catalytically active zone and the second catalytically active zone is the same and is 1:1, and
the total concentration of platinum and palladium in the first catalytically active zone is greater than in the second catalytically active zone.

In embodiments of the present invention, the length E of the first catalytically active zone is 20% to 70%, 40% to 60% or 45% to 50% of the total length L. The length Z of the second catalytically active zone, in embodiments of the present invention, is 20% to 70%, 40% to 60% or 45% to 50% of the total length L. In preferred embodiments, the lengths E and Z are both 50% of the total length L.

The sum total of the length E of the first catalytically active zone and the length Z of the second catalytically active zone may correspond exactly to the total length L. For production-related reasons in particular, however, in embodiments of the present invention, it may be less than the total length L. In these cases, a particular length of the total length L between the coated lengths E and Z is uncoated. For example, the sum total of the length E of the first catalytically active zone and the length Z of the second catalytically active zone is L×0.8 to L×0.999.

The first end of the support body is also referred to hereinafter as the entry end, and the second end also as the exit end.

In the diesel oxidation catalyst of the invention, the first catalytically active zone and the second catalytically active zone have equal thermal masses. The term “thermal mass” is also known to the person skilled in the art as heat capacity and can be determined by known methods described in the literature. Incidentally, it is in common use in the specialist field of significance here; see, for example, DE 102010063714 A1.

“Equal thermal mass” means, for example, that the washcoat loading of the first and second catalytically active zones is the same. It may vary within wide limits according to the application and is, for example, 50 to 400 g/L. Alternatively, equal thermal masses of the first and second catalytically active zones, given a different washcoat loading, can also be achieved through the use of compacted washcoat constituents. Useful materials for this purpose are especially support materials such as compacted alumina.

For the avoidance of misunderstanding, it is pointed out that the calculation of the thermal masses does not include the thermal mass of the noble metal content because it is negligibly small.

The noble metal loading in each of the first and second catalytically active zones may be 10 g/ft³ (0.35315 g/L) to 220 g/ft³ (7.76923 g/L). In other embodiments, the noble metal loading may also be 15 g/ft³ (0.52972 g/L) to 70 g/ft³ (2.47203 g/L).

In one embodiment of the diesel oxidation catalyst of the invention, the first catalytically active zone contains 1, 2 to 4 times as much platinum and palladium as the second catalytically active zone. For example, 55% to 80% by weight, 55% to 70% by weight or 57% to 60% by weight of the total amounts of platinum and palladium present in the catalyst is in the first catalytically active zone.

The absolute noble metal content of the diesel oxidation catalyst of the invention is, for example, 10 to 200 g/ft³ (0.35315 to 7,063 g/L), 10 to 100 g/ft³ (0.35315 to 3.5315 g/L) or 15 to 50 g/ft³ (0.52973 to 1.76575 g/L).

In embodiments of the oxidation catalyst of the invention, platinum and palladium have been applied in both zones to one or more high-melting, high-surface area support oxides. Suitable support oxides are, for example, aluminum oxides, silicon oxides, zirconium oxide- and/or titanium oxide-doped aluminum oxides and aluminum-silicon mixed oxides.

For production of a suitable coating suspension, the selected support oxides are suspended in water. Platinum and palladium are added to the suspension while stirring in the form of suitable water-soluble precursor compounds, for example palladium nitrate or hexahydroxoplatinic acid, and fixed on the support material if necessary by adjusting the pH and/or by adding an auxiliary reagent.

Alternatively, the noble metal can also be applied to the support material in analogy to the process described in EP 1 101 528 A2.

The abovementioned precursor compounds and auxiliary reagents are familiar to those skilled in the art. The suspensions thus obtained are then ground and applied to an inert support body by one of the conventional coating methods. After each coating step, the coated part is dried in a hot air stream and optionally calcined.

The diesel oxidation catalysts of the invention are suitable for cleaning the exhaust gases of diesel engines, especially in respect of carbon monoxide and hydrocarbons.

The present invention thus also relates to a method of treating diesel exhaust gases, which is characterized in that the diesel exhaust gas is passed over a diesel oxidation catalyst as described and defined above.

The diesel oxidation catalysts of the invention are especially used as constituents of exhaust gas cleaning systems. Corresponding exhaust gas cleaning systems comprise, as well as a diesel oxidation catalyst of the invention, for example, a diesel particulate filter and/or a catalyst for selective catalytic reduction of nitrogen oxides, in which case the diesel particulate filter and SCR catalyst are typically connected downstream of, i.e. on the outflow side of, the diesel oxidation catalyst of the invention. In one embodiment of the exhaust gas cleaning system, the SCR catalyst is disposed atop the diesel particulate filter.

### EXAMPLE 1

a) A commercial porous aluminum-silicon mixed oxide was pre-loaded with Pt and Pd salts via a pore volume impregnation. Subsequently, the powder was dried and then heat-treated. This noble metal-coated material was subsequently introduced into a suspension of platinum-laden commercial zeolite. This was followed by grinding and application of the resultant washcoat to a ceramic cordierite honeycomb up to 50% of the substrate length, and drying. The substrate zone thus obtained is the exhaust gas-side outlet zone on use of the diesel oxidation catalyst.

b) The coating of the second 50% of the ceramic honeycomb, which is the inlet zone on use of the diesel oxidation catalyst, was effected with a washcoat which was produced analogously to the method described in a), with the difference that the total concentration of the noble metals used (based on the porous aluminum-silicon mixed oxide and on the platinum-laden zeolite) was 2.6 times higher.

On completion of coating of the second zone, the catalyst was again dried and then heat-treated and then reduced.

c) The diesel oxidation catalyst obtained according to a) and b) (called C1 hereinafter), which had a total noble metal content of 0.99163 g/L with a ratio of Pt/Pd=1/1, was used in exhaust gas flow direction as described above. The performance thereof in terms of carbon monoxide (CO) conversion and hydrocarbon (HC) conversion in the fresh and aged state was significantly improved over a comparative catalyst (called CC1 hereinafter) which had been coated homogeneously with the same feedstocks, having the same noble metal content and ratio of Pt to Pd.

This is apparent from the light-off temperatures below, which were each obtained under identical test conditions in a model gas system. The aging was effected in each case by hydrothermal treatment at 750° C. for 16 hours.

| | Light-off temperature (T50 CO or T50 THC) [° C.] | | | |
|---|---|---|---|---|
| | CO fresh | CO aged | HC fresh | HC aged |
| C1 | 109 | 148 | 133 | 161 |
| CC1 | 130 | 158 | 143 | 171 |

### EXAMPLE 2

A ceramic cordierite honeycomb was coated as described in example 1b) over 50% of its length. For coating of the outlet zone, a washcoat containing the same zeolite component and the same aluminum-silicon mixed oxide as described in example 1a) was prepared, except that Pt and Pd were applied with the same masses by aqueous injection of the noble metal salts. The coating was followed by drying, heat treatment and reduction. The catalyst (called C2 hereinafter) having a total Pt/Pd noble metal ratio of 1:1 and a noble metal content of 0.99163 g/L was compared with the comparative catalyst CC1 as described in example 1, with the following results:

| | Light-off temperature (T50 CO or T50 THC) [° C.] | | | |
|---|---|---|---|---|
| | CO fresh | CO aged | HC fresh | HC aged |
| C2 | 120 | 145 | 137 | 158 |
| CC1 | 130 | 158 | 143 | 171 |

### EXAMPLE 3

a) A ceramic cordierite honeycomb having a length of 4″ was loaded over 50% of its length with a washcoat which contained 15 g/ft³ of Pt+15 g/ft³ of Pd. This was followed by drying at 110° C. and calcination at 450° C. The zone thus obtained is the inlet zone on use of the diesel oxidation catalyst.

b) The second 50% of the honeycomb was coated with a washcoat which contained 7.5 g/ft³ of Pt+ 7.5 g/ft³ of Pd, and was otherwise identical to the washcoat used in step a). Again, drying was effected at 110° C. and calcination at 450° C. The zone thus obtained is the exit zone on use of the diesel oxidation catalyst.

The diesel oxidation catalyst thus obtained is called C3 hereinafter. The total noble metal loading is 22.5 g/ft³, with the same weight ratio of platinum and palladium in the two zones of 1:1 in each case. The thermal masses in the two zones are equal.

c) For comparison, the above-described steps a) and b) were repeated, with the difference that 20 g/ft³ of Pt+ 10 g/ft³ of Pd were used in the inlet zone, and 10 g/ft³ of Pt+ 5 g/ft³ of Pd in the outlet zone.

The diesel oxidation catalyst thus obtained is called CC2 hereinafter. The total noble metal loading is again 22.5 g/ft³; the weight ratio of platinum and palladium in the two zones is the same again, but is 2:1 in each case. The thermal masses in the two zones are equal.

d) The performance in terms of carbon monoxide and hydrocarbon conversion of catalysts C3 and CC2 in the fresh and aged state

(a) 16 hours of hydrothermal oven aging at 750° C.; b) 16 hours of hydrothermal oven aging at 800° C.) was determined in a customary manner in a model gas system. The following results were obtained:

| | Light-off temperature (T50 CO or T50 THC) [° C.] | | | | | |
|---|---|---|---|---|---|---|
| | CO | CO | CO | HC | HC | HC |
| | fresh | aged a) | aged b) | fresh | aged a) | aged b) |
| C3 | 132 | 137 | 144 | 160 | 154 | 161 |
| CC2 | 149 | 142 | 150 | 167 | 157 | 165 |

1. A diesel oxidation catalyst comprising a support body of length L which extends between a first end and a second end, and a catalytically active coating disposed on the support body, composed of a first catalytically active zone and a second catalytically active zone, wherein
the support body is a ceramic or metallic flow-through honeycomb,
the first catalytically active zone, proceeding from the first end, extends for a length E of 5% to 95% of the total length L,
the second catalytically active zone, proceeding from the second end, extends for a length Z of 5% to 95% of the total length L,
E+Z≦L,
the first catalytically active zone and the second catalytically active zone have equal thermal masses,
the first catalytically active zone and the second catalytically active zone each contain platinum and palladium as catalytically active constituents,
the weight ratio of platinum to palladium in the first catalytically active zone and the second catalytically active zone is the same and is 1:1, and
the total concentration of platinum and palladium in the first catalytically active zone is greater than in the second catalytically active zone.

2. The diesel oxidation catalyst as claimed in claim 1, wherein the length E of the first catalytically active zone is 20% to 70%, 40% to 60% or 45% to 50% of the total length L.

3. The diesel oxidation catalyst as claimed in claim 1, wherein the length Z of the second catalytically active zone is 20% to 70%, 40% to 60% or 40% to 50% of the total length L.

4. The diesel oxidation catalyst as claimed in claim 1, wherein the sum total of the length E of the first catalytically active zone and the length Z of the second catalytically active zone is L×0.8 to L×0.99.

5. The diesel oxidation catalyst as claimed in claim 1, wherein the noble metal loading in each of the first and second catalytically active zones is 1.0 g/ft³ (0.35315 g/L) to 220 g/ft³ (7.76923 g/L).

6. The diesel oxidation catalyst as claimed in claim 1, wherein the noble metal loading in each of the first and second catalytically active zones is 15 g/ft³ (0.52972 g/L) to 70 g/ft³ (2.47203 g/L).

7. The diesel oxidation catalyst as claimed in claim 1, wherein the first catalytically active zone contains 1.2 to 4 times as much platinum and palladium as the second catalytically active zone.

8. The diesel oxidation catalyst as claimed in claim 1, wherein it has an absolute noble metal content of 10 to 200 g/ft³ (0.35315 to 7.063 g/L), 10 to 100 g/ft³ (0.35315 to 3.5315 g/L) or of 15 to 50 g/ft³ (0.52973 to 1.76575 g/L).

9. A method of treating diesel exhaust gases, wherein the diesel exhaust gas is passed over a diesel oxidation catalyst as claimed in claim 1.

10. An apparatus for cleaning the exhaust gases of diesel engines, including a diesel oxidation catalyst as claimed in claim 1.

11. The apparatus as claimed in claim 10, further comprising a diesel particulate filter and/or or a catalyst for selective catalytic reduction of nitrogen oxides, and the diesel oxidation catalyst is connected upstream of the diesel particulate filter and/or or the catalyst for selective catalytic reduction of nitrogen oxides.
